(19) United States
(12) Patent Application Publication
(10) Pub. No.: US 2026/0115761 A1
(43) Pub. Date: Apr. 30, 2026

(54) PROCESS FOR STRUCTURING A SURFACE THROUGH INDIRECT SUBJECTION TO A TREATMENT MEDIUM, AND EDGE STRIP PRODUCED THEREBY

(71) Applicant: Fritz Egger GmbH & Co. OG, St. Johann, Tirol (AT)

(72) Inventor: Jean-Pascal Lafleur, Olsberg (DE)

(21) Appl. No.: 19/168,796

(22) PCT Filed: Mar. 21, 2024
(86) PCT No.: PCT/EP2024/057537

§ 371 Date: Sep. 24, 2025

(30) Foreign Application Priority Data
Mar. 31, 2023 (EP) 23165856.8

(51) Int. Cl. B05D 7/02; B05D 1/00

(52) U.S. Cl. CPC B05D 7/02; B05D 1/002; B05D 2201/02

(57) ABSTRACT

A process for treatment of a surface in which a substrate having a surface is provided, wherein the surface at least partially comprises a polymer material, wherein the polymer material contains a thermoplastic and/or a thermoplastic elastomer and wherein the polymer material is at least partially in a molten state at the surface of the substrate, and in which a liquid treatment medium is applied to a carrier medium, characterized in that the liquid treatment medium is transferred from the carrier medium onto the surface of the substrate before completed solidification of the polymer material, preferably before commencement of a solidification process of the polymer material, and in that the transferred treatment medium interacts with the surface of the substrate in such a way that a surface structuring is produced at the surface of the substrate. An edge strip comprising a surface structuring produced by the process is also described.

### CROSS-REFERENCE TO RELATED APPLICATIONS

The present application claims priority to PCT International Patent Application No. PCT/EP2022/057537, filed Mar. 21, 2024, and European Patent Application No. 23165856.8, filed on Mar. 31, 2023, the disclosures of which are incorporated herein by reference.

### STATEMENT RE: FEDERALLY SPONSORED RESEARCH/DEVELOPMENT

Not Applicable

### BACKGROUND

The present invention relates to a method for treating a surface, in which a substrate having a surface is provided, wherein the surface at least partially comprises a polymer material, wherein the polymer material contains a thermoplastic and/or a thermoplastic elastomer, wherein the polymer material at the surface of the substrate is at least partly in a molten state, wherein the polymer material at the surface of the substrate is at least partially in a molten state, and wherein a liquid treatment medium is applied to a carrier medium. The present disclosure further relates to an edge strip having a base body and having at least one layer close to the surface, wherein the at least one layer close to the surface is formed at least partially from a polymer material, wherein the polymer material contains a thermoplastic and/or a thermoplastic elastomer, and wherein the surface has a surface structuring.

From the prior art, and particularly in the field of furniture and laminate flooring production, it is known to provide surfaces with a structure by an embossing method. Traditionally, a structure generator such as for example an embossing roller with a three-dimensional surface structure is used, which corresponds to a negative image of the structural pattern to be applied. In addition, the use of structure generators in the form of structure generator sheets, strips or foils that also bear a three-dimensional surface structure is also known. This means that a desired structural pattern is pressed into the surface during surface preparation, just as when using an embossing roller with a three-dimensional surface structure.

For both known structuring methods, an element is accordingly used that bears the pattern or is provided with the pattern or has a three-dimensional surface structure corresponding to the pattern. The production of such a structured structure generator is complex and costly. In addition, a production time of 4 to 6 months is generally to be expected for a structured embossing roller, which then results in long delivery times for the production of the final products such as laminate flooring or furniture.

In addition, a structuring method using a structured element presents complex challenges such as the precise adjustment of the embossing roller or the press for pressing the structure generator into the surface to be prepared for a specific structural depth of the pattern. The removal of the structure generator texture can also be problematic since this can lead to stretchings or distortions of the pattern on the surface being prepared. In addition, less prominent structures or patterns are often preferred in order to make repetitions of the so-called repeat or maximum length of the pattern, which is limited by the circumference of the embossing roller, appear less conspicuous. For example, in this regard, a repeat or a repetition of the pattern on the surface to be prepared in a magnitude of approximately 50 cm is conceivable.

Digital printing has improved the preparation of surfaces with patterns, for example, by patterns no longer being limited by the circumference of an embossing roller or by allowing application of a pattern or decoration with an endless length. Nevertheless, providing a structure to a surface to be prepared, i.e. a three-dimensional pattern, remains problematic. To achieve surface structuring, the substrate can be prepared in separate method steps, first by embossing in order to create a specific embossed pattern on the surface, then by digital printing to apply an image to the embossed surface. However, the coordination of such method steps is challenging, and often a surface is obtained with an embossment and an image that do not match each other optimally.

DE 10 2015 110 236 B4 discloses a method and a device for producing a structure on a surface of a flat workpiece. Here, in a first step, a workpiece is coated with a liquid base layer in the form of an acrylic paint, and in a second step, liquid droplets are sprayed thereon. In a third step, the liquid base layer and the sprayed-on liquid droplets are dried together. DE 10 2015 110 236 B4 therefore discloses a dispersion that is modified and not a polymer melt.

In particular, there are also hurdles in the provision of a new embossing roller, not only from the aspect of structuring the embossing roller surface itself but also from the aspect of installing the new embossing roller in the production line with a crane and the precise adjustment of the embossing parameters such as penetration depth, etc.

Against this background, the object of the present invention is based on improving known methods for treating a surface and, in particular, on providing a method which simultaneously offers increased flexibility in the production of edge strips and an optimal surface structuring quality.

### BRIEF SUMMARY

The aforementioned object is achieved according to the invention by a method for treating a surface, in which a substrate is provided with a surface, wherein the surface at least partially comprises a polymer material, wherein the polymer material contains a thermoplastic and/or a thermoplastic elastomer, and wherein the polymer material at the surface of the substrate is at least partially in a molten state, in which a liquid treatment medium is applied to a carrier medium, characterized in that the liquid treatment medium is transferred from the carrier medium to the surface of the substrate before the polymer material has completely solidified, preferably before the start of a solidification process of the polymer material, and in that the transferred treatment medium interacts with the surface of the substrate in such a way that a surface structure is produced.

Also disclosed is an edge strip with a base body and with at least one layer close to the surface, wherein the at least one layer close to the surface is formed at least partially from a polymer material, wherein the polymer material contains a thermoplastic and/or a thermoplastic elastomer, and wherein the layer close to the surface has a surface structuring, characterized in that the surface structuring has been produced by a method according to the present disclosure.

Due to the liquid treatment medium a great flexibility in use is achieved, wherein at the same time, high-quality structuring on a surface can be achieved. In particular, this allows a complex and time-consuming provision of an embossing roller with a three-dimensional surface relief to be dispensed with. Furthermore, the method can be carried out following a manufacturing method for the substrate in a simple, cost-effective and space-saving manner in comparison to an embossing method by means of an embossing roller. In addition, a wide variety of surface structuring types can be achieved by selecting the composition, the temperature and other properties of the treatment medium.

In the context of the present invention, the term “substrate” is understood as a carrier or body that has at least one surface. The substrate can be single-piece or multi-piece, have a layered structure with layers that have different material compositions, have a sandwich structure, or be a solid component. In particular, the substrate can be a film, an intermediate product or component for the production of furniture, flooring, automobiles, windows or similar. The substrate can be provided by injection molding, extrusion, rolling, pressing, calendering, wherein these processes can be carried out individually or in combination. For example, a polymer material can be provided by means of an extruder before being fed into a mold by injection. Furthermore, the substrate can be provided by means of several manufacturing steps that take place one after the other. An example of this is a substrate that is first provided by extrusion and then by means of rolling or calendering.

The substrate can be provided as an extrudate by being produced by extrusion, in particular by co-extrusion or by post-co-extrusion. Co-extrusion can be understood as the simultaneous extrusion of at least two polymer materials through a single nozzle. This results in a single extruded product having a plurality of layers of different compositions and that are bonded together. In post-co-extrusion, the at least two polymer materials can be brought together with a time delay to form the substrate. For example, first a base body can thus be produced by a first extruder, and then a surface layer can be applied to the base body by means of a further extruder downstream of the first extruder. The base body can thus be at least partially solidified when the surface layer is applied as a melt stream.

The surface of the substrate comprises at least one polymer material. A polymer material for the purposes of the present invention is a chemical substance that consists of macromolecules. In this case, the macromolecules have one or more structural units or repeating units that are the same or different. A polymer material can be natural, i.e. produced by living organisms, or synthetic. The term polymer material includes, among other things, thermoplastics, elastomers, thermosets and thermoplastic elastomers.

In the present case, the polymer material contains a thermoplastic and/or a thermoplastic elastomer. In this regard, thermoplastics, also called plastomers, can be in particular plastics that can be deformed within a certain temperature range. This process is reversible, meaning it can be repeated as often as required by cooling and reheating to the molten state as long as so-called thermal decomposition of the material does not occur due to overheating. This is where thermoplastics differ from thermosets and elastomers. Another unique selling point is the weldability of thermoplastics.

A thermoplastic elastomer should be understood as a material that becomes thermoplastic and thus flowable when heat is supplied. The material can be elastic at the usual ambient temperature, especially at room temperature. In particular, the elastic properties of the polymer material arise from the simultaneous presence of physical crystalline or semi-crystalline and elastic regions in the material mass at the working temperature. Thermoplastic elastomers are, for example, block copolymers which include thermoplastic styrene elastomers (TPS), thermoplastic urethane elastomers (TPU), thermoplastic polyamide elastomers (TPA), and thermoplastic copolyester elastomers (TPC). Elastomer alloys (so-called “blends”) such as thermoplastic olefin elastomers (TPO) and thermoplastic vulcanizates (TPV) also belong to the thermoplastic elastomers.

Various thermoplastics and/or thermoplastic elastomers can be used for the polymer material. The polymer material is expediently selected according to the desired properties of the surface of the substrate, in particular of the film or the edge strip. Preferably, the polymer material is selected from the group consisting of polyethylene, polypropylene, acrylonitrile-butadiene-styrene copolymer, polyvinyl chloride, polymethyl methacrylate, polyethylene terephthalate, polylactic acid, thermoplastic styrene elastomers (TPS), thermoplastic urethane elastomers (TPU), thermoplastic polyamide elastomers (TPA), thermoplastic copolyester elastomers (TPC), thermoplastic olefin elastomers (TPO), thermoplastic vulcanizates (TPV), and mixtures thereof. More preferably, the polymer material is selected from the group consisting of polyethylene, polypropylene, acrylonitrile-butadiene-styrene copolymer, polyvinyl chloride, polymethyl methacrylate, polyethylene terephthalate and mixtures thereof.

The substrate is provided with a surface, wherein the polymer material at the surface of the substrate is at least partially in a molten state. The molten state is preferably caused by a melting process and corresponds to a liquid or viscous aggregate state of the polymer material on the surface of the substrate, wherein in the context of the invention, the term “molten state” comprises aggregate states of the polymer material in which the polymer material is not completely solidified or crystallized. The polymer material at the surface of the substrate which is in a molten state preferably has a temperature which exceeds the melting temperature of the polymer material, in particular a temperature which exceeds the melting temperature of the polymer material by at least 15° C., preferably by at least 20° C., more preferably by at least 25° C., even more preferably by at least 30° C., in particular by an amount in the range of 20 to 30° C.

During a melting process, the polymer material on the surface of the substrate is exposed to temperature and pressure conditions that lead to a phase transition of the polymer material from a solid state into a liquid or viscous state. In particular, during a melting process, the melting temperature or glass transition temperature is exceeded at the pressure then prevailing.

The liquid treatment medium is applied to a carrier medium. A carrier medium within the meaning of the invention can be a roller, in particular the surface of a roller, a plate, a strip, a foil or another object which is suitable for transferring the liquid treatment medium applied to the carrier medium to the substrate by coming into contact with the substrate, either individually or in conjunction with a roller.

The application of the treatment medium to the carrier medium can be carried out, for example, by being applied as droplets, by immersion in a bath, wherein the liquid treatment medium floats at the surface of another liquid, by thermal transfer, by spreading, by application by means of a nozzle, wherein the treatment medium is directed under pressure towards the carrier medium.

The liquid treatment medium is transferred from the carrier medium to the surface of the substrate. The transfer is preferably carried out by bringing together the carrier medium and the surface of the substrate. The carrier medium and the surface of the substrate can here be brought into contact, in particular pressed together. Preferably, the transfer is carried out in such a way that a pattern with which the treatment medium was applied to the carrier medium is replicated at the surface of the substrate.

The liquid treatment medium is transferred to the surface of the substrate before the polymer material has completely solidified, preferably before the start of a solidification process of the polymer material. Alternatively or additionally, the polymer material can be exposed to the liquid treatment medium in a liquid aggregate state, in a partially liquid aggregate state and/or in a partially solidified aggregate state. In particular, the application of the liquid treatment medium to the surface can at least partially initiate solidification of the polymer material at the surface, advantageously where the liquid treatment medium comes into contact with the surface of the substrate. Solidification can be caused, for example, by the treatment medium leading to increased cooling, particularly where it is in contact with the surface, or by initiating crystallization, for example by nucleation.

In the present case, the term “solidification” is intended to encompass the transition process in the aggregate state in which the polymer material changes from an at least partially liquid or viscous state to a solid state, in particular from the molten state to a solid state. The polymer material is completely solidified when it has become solid throughout its entire mass.

The transferred treatment medium interacts with the surface of the substrate in such a way that a surface structuring is created. Examples of interaction within the meaning of the present disclosure are: a chemical reaction, an influencing of material properties, a local acceleration or slowing down a change of state, although this list is not exhaustive.

This means that in order to obtain a surface structuring of the substrate a preparation step with a displacement of material or the use of a structuring agent with a three-dimensional embossed surface can be dispensed with.

“Surface structuring” is primarily to be understood as the result of a targeted adaptation of material properties and/or the material composition of a surface. These include, for example, surfaces that each have areas with different compositions, crystal structures, roughnesses, refractive indices, surface tension coefficients, and light reflection coefficients. The surface structuring can be three-dimensional, in particular at the microscopic level. Such three-dimensional surface structuring is achieved, for example, when the surface has areas with different surface roughnesses. This creates a microscopic surface topology.

The surface structuring can lend the surface a certain aesthetic and/or a certain functionality, in particular one that the surface would not have without treatment. Examples of such an aesthetic are an imitation of a stone or metal surface, a matte or glossy effect, a special coloring, a smoothing, etc. Examples of surface functionalization are a change in scratch resistance, an increase or decrease in permeability to gases or liquids, a change in resistance to environmental influences, a change in surface tension or surface hardness, an antimicrobial effect, a self-cleaning effect, a change in sliding properties or wetting behavior.

The surface of the substrate can at the time of provision already have a surface structure, i.e. before treatment by means of the liquid treatment medium, for example a roughness or pattern caused by a previous manufacturing step.

An edge strip can, for example, be an extruded profile that is provided to improve the aesthetics of a piece of furniture or intended as a transition between a floor covering and a wall.

The edge strip has a base body and a near-surface layer. In this case, the near-surface layer can be a region of the base body so that the edge strip is solid and the surface that is treated by the method is a surface of the base body. The near-surface layer can also be a layer that differs from the base body in its material composition. Alternatively, the near-surface layer can have the same material composition as the base body but can be manufactured separately from the base body and later arranged on a surface of the base body or bonded to the base body.

Preferably, the near-surface layer has a thickness that is equal to or greater than the depth of the surface structuring. This allows the properties of the near-surface layer to be used for surface structuring, and the base body can be used, for example, as a more cost-effective carrier. Alternatively, or at least in some regions, the near-surface layer can have a thickness that is less than the depth of the surface structuring. The properties of not only the near-surface layer but also the base body arranged underneath it can thus contribute to the aesthetic and/or functional effect of the surface structuring.

The surface structuring of the edge strip has been produced by a method according to the present invention. Such a surface structuring has, for example, a repeat length that is greater than a repeat length of a surface treated by means of an embossing roller.

The individual embodiments of the method and of the edge strip described below can be combined with each other as desired. Furthermore, the method steps can be carried out in any order, preferably in the specified order.

In a first embodiment of the method, the polymer material on the surface of the substrate has already been cooled and solidified at least once, and the polymer material is converted into a molten state again to provide the substrate with a surface.

This allows substrates to be stored and/or transported as intermediate products after their production, as required, before their surface is treated. This also makes it possible to provide the substrate as an injection-molded part, wherein the substrate has been injected into a mold and has already been cooled at least once, for example by the mold itself.

The re-conversion into the molten state is preferably carried out by means of a method step prior to the application of the liquid treatment medium to the surface, in which the polymer material is heated on the surface of the substrate.

In a further embodiment of the method, the substrate is formed in one or more layers, in particular as a sandwich structure.

End products can thus be achieved with a character that is adapted with regard to cost savings and/or specific uses on the one hand, and on the other hand with a relatively high degree of design freedom with regard to the aesthetics and/or functionality of the surface.

In a further embodiment of the method, the substrate is provided in the form of a co-extruded edge strip with a near-surface layer and a base body, wherein the near-surface layer comprises a first polymer material with a first melt viscosity, and the base body comprises a second polymer material with a second melt viscosity, and wherein the first melt viscosity is lower than the second melt viscosity.

In a corresponding embodiment of the edge strip, the base body comprises a first polymer material, wherein the first polymer material contains a first thermoplastic and/or a first thermoplastic elastomer. Furthermore, the at least one near-surface layer has a second polymer material and is arranged on an outer side of the base body, wherein the second polymer material contains a second thermoplastic and/or a second thermoplastic elastomer, and the first polymer material and the second polymer material are different.

A substrate is thus provided with a base body and a near-surface layer that have different solidification temperatures. In other words, the substrate can be provided such that the base body is in a solid state and the near-surface layer is in a molten state. This allows changes in the properties of the base body, which can cause a transition to a molten state, to be avoided, wherein at the same time optimal conditions are created for the production of surface structuring on the near-surface layer.

In a further embodiment of the method, the substrate is provided as an extrudate, and the substrate is exposed to the liquid treatment medium before the start of a cooling step.

This allows substrates such as extruded profiles to be treated in an industrial manner. Furthermore, existing production lines can thus be supplemented or retrofitted by means of the method.

Preferably, the surface is exposed to the liquid treatment medium immediately upon exiting an extruder. The present method can thus be carried out following a manufacturing step of an extrusion method. As a result, the entire production time of, for example, an edge strip with surface structuring can be optimized.

The cooling step can be actively supported, for example by using a cooling or cooled roller, by applying a cooling mist, by quenching or similar. Alternatively or additionally, the cooling step can be carried out by storage in air.

In a further embodiment of the method, the substrate is provided as an injection-molded part produced by means of an injection-molding process, wherein the polymer material has been converted back into a molten state after the injection-molding process.

Injection molding is a commonly used method that makes it possible to produce large quantities within a short time. As a rule, a material in a liquid or viscous state is injected into a mold, wherein the material then cools in the mold and assumes the shape of the mold. With the method in the present embodiment, the surface of an injection-molded part produced in this way can be treated, and its surface can be given a surface structuring. Overall, this allows products to be manufactured on an industrial scale. At the same time, subsequent heating or subsequent re-conversion of the surface into the molten state allows increased flexibility in logistics since the injection-molded part can be stored, transported or the like before surface treatment with the liquid treatment medium without these intermediate steps having an influence on the quality of the surface structuring.

Preferably, the surface of the substrate or the polymer material is converted into a molten state by heating. Heating can be effected by means of heat lamps, radiant heaters and/or lasers.

In a further embodiment of the method, the liquid treatment medium is applied to the carrier medium according to a prespecified pattern, and the pattern is reproduced when the liquid treatment medium is transferred from the carrier medium to the surface of the substrate in such a way that the surface structuring corresponds to the pattern.

By specification of a desired pattern in advance, a surface structuring can be reproduced from one substrate to another, which increases the repeatability of the method and the reliability of the method result. In addition, a pattern can be planned and designed as desired to give the surface of the substrate an appropriate aesthetic and/or functionality.

The pattern can be two-dimensional. In this case, the pattern extends essentially in one plane. The result of the method is then a substrate with an essentially flat surface on which the pattern is reproduced.

The pattern can be three-dimensional. Such a pattern is understood as a three-dimensional topology that is in particular visible at the microscopic level, such as a variation in surface roughness and/or atomic arrangement over the surface of the substrate. For example, a substrate with matte and glossy areas at the surface can be a result of the method.

The pattern may have been selected depending on a desired aesthetic and/or a specific functionality, in particular one that the surface would not have without treatment.

The liquid treatment medium can be pressurized and applied to the surface of the carrier medium with the aid of a nozzle, a print head and/or through a mask to create the prespecified pattern on the surface of the carrier medium.

In a further embodiment of the method, the liquid treatment medium is provided with properties that have been selected depending on at least one property of the polymer material.

In this way, the liquid treatment medium can be tailored to the surface to be treated. This opens up expanded fields of application for the method by allowing substrates of different compositions, especially with polymer materials of different types, to be treated. With the method, surface structuring of different types can then be achieved, whether with a special look, feel or functionality.

Examples of polymer material properties include: substrate preparation temperature, melt viscosity, thermal conductivity, heat capacity, scratch resistance, elastic modulus, plastic modulus, hardness, flowability, microstructure, nanostructure, polymer chain arrangement, crystalline arrangement, color, light transmittance, light reflectance, surface tension, electrical charge, polarity, permittivity, electrical conductivity, surface roughness, chemical resistance, pH value, and more. For a polymer material that contains at least two different polymer materials, the liquid treatment medium can be selected taking into account at least one property of each of the polymer materials.

Examples of properties of the liquid treatment medium are: quantity, temperature during application of the liquid treatment medium to the surface, boiling point, thermal conductivity, heat capacity, flowability, microstructure, nanostructure, polymer chain arrangement, crystalline arrangement, color, light transmittance, light reflectance, surface tension, electrical charge, polarity, permittivity, electrical conductivity, density, viscosity, thixotropy and others. For example, the viscosity or thixotropy of the treatment medium can have an influence its flow behavior on the surface to be treated.

For example, it can be provided that the treatment medium and the surface have temperatures selected in such a way that the treatment medium evaporates after being transferred to the surface.

Various treatment media can be used for the method. The treatment medium is preferably selected according to the desired properties of the edge strip or of the surface structuring to be created. Preferably, the treatment medium is selected from the group consisting of water, nucleating agent; dye; UV pigment; microbiocide; gloss control agent; matting agent, and mixtures thereof.

In a further embodiment of the method, the liquid treatment medium contains at least one nucleating agent.

By a nucleating agent being applied to the surface, the number of nucleation nuclei that arise at the beginning of a crystallization method in polymer materials is increased, at least locally. This can make it possible, for example, to achieve structuring in polymers that have a different volume in the crystalline state than in the amorphous state. Furthermore, the mechanical properties of the polymer material can be improved and crystallization accelerated, which in turn makes possible an increase in cycle time during preparation.

Examples of nucleating agents are: dibenzylidene sorbitol (DBS), bis(p-methyl-dibenzylidene sorbitol) (MDBS), bis(p-ethyldibenzylidene sorbitol) (DMDBS), sodium 2,2′-methylene-bis-(4,6-di-tert-butyl-phenyl) phosphate, aluminum hydroxy-bis(4-tert-butylbenzoate), N,N′-dicyclohexyl-2-6-naphthalenedicarboxamide, 4-biphenylcarboxylic acid, thymine, talc, sodium benzoate.

In a further embodiment of the method, the liquid treatment medium contains at least one additive, in particular an additive from the list: dye; UV pigment; microbiocide; gloss control agent; matting agent.

This allows several effects to be achieved simultaneously, for example improved mechanical and optical properties of the polymer material on the treated surface.

In a further embodiment of the method, the polymer material of the substrate has been selected with respect to its melt viscosity.

In particular, optimal surface structuring can be achieved by selecting both the polymer material on the basis of its melt viscosity as well as the liquid treatment medium on the basis of this melt viscosity.

In a further embodiment of the method, two or more portions of the treatment medium are transferred to the surface of the substrate, wherein the portions of the treatment medium have different temperatures. Alternatively, at least a first and a second treatment medium are transferred to the surface of the substrate.

Due to the different temperatures, a heterogeneous surface structuring can be achieved. An example of this is a surface structuring with matte regions and shiny regions.

The portions of liquid treatment medium can have the same composition, but can each be placed in containers separate from each other at a prespecified temperature before being applied to the surface simultaneously or with a time delay relative to each other.

The at least two liquid treatment media can differ, for example, in their composition or physical state and can be applied to the surface simultaneously or with a time delay relative to each other.

Alternatively or additionally, at least a first and a second treatment medium can be provided and applied to the surface, wherein the first treatment medium and the second treatment medium have different polarities, solubilities and/or surface tensions.

In a further embodiment of the method, the liquid treatment medium is applied to the carrier medium by means of an ink-jet method.

Using the ink-jet method, locally limited surface areas of the carrier medium can be precisely applied, and thus a high-quality surface structuring of the surface of the substrate can be achieved even indirectly.

In a further embodiment of the method, the liquid treatment medium is applied to the carrier medium by means of an airbrush method.

In a further embodiment of the method, the liquid treatment medium is applied to the carrier medium by means of high-speed rotary atomization.

This allows comparatively larger surface areas of the carrier medium to be treated in one go.

In general, these embodiments offer the advantage that already available means can be used or adapted to carry out the method.

In a further embodiment of the method, after the transfer of the liquid treatment medium to the substrate, the surface of the substrate is post-treated, in particular in a cooling step and/or in a fixing step.

This allows the surface structuring to be permanently established or made more resistant. Furthermore, the surface having the surface structuring can be treated with a further agent, such as a lacquer, a resin or a primer, in order to create an additional layer on the surface structuring, and/or can be subjected to a plasma treatment.

In a further embodiment of the method, the temperature of the carrier medium is selected depending on properties of the liquid treatment medium and/or depending on properties of the polymer material of the surface of the substrate.

The temperature of the carrier medium can, for example, be selected such that the properties, in particular the temperature, of the treatment medium applied to the carrier medium can be controlled.

In a further embodiment of the method, the material composition of the carrier medium, in particular the material composition of the surface of the carrier medium, is selected depending on properties of the liquid treatment medium and/or depending on properties of the polymer material of the surface of the substrate.

In this way, interactions between the treatment medium and the carrier medium can be used in a targeted manner, for example to influence the transfer of the treatment medium from the carrier medium to the surface of the substrate. The material composition of the carrier medium can, for example, contain steel or plastic.

In a further embodiment of the method, for the transfer of the liquid treatment medium from the carrier medium to the surface of the substrate, the substrate wraps at least partially around the carrier medium with a wrap angle, and the wrap angle is selected depending on properties of the liquid treatment medium and/or depending on properties of the polymer material of the surface of the substrate. Alternatively, the wrap angle is selected depending on the properties of a desired surface structuring.

In particular, if the carrier medium is a roller or has a rolling element, a period of time in which the substrate is brought together with the carrier medium, in particular in which the substrate comes into contact with the carrier medium, can be controlled. By increasing the wrap angle, a contact time of the carrier medium with the surface of the substrate can be extended, and by reducing the wrap angle, a contact time of the carrier medium with the surface of the substrate can be shortened.

In addition, force transmission between the carrier medium and the surface of the substrate can be adjusted by varying the wrap angle.

In a further embodiment of the edge strip, a first near-surface layer is provided on a first side of the base body, and a second near-surface layer is provided on a second side of the base body facing opposite the first side of the base body. In addition, the first near-surface layer has a first surface structuring, and the second near-surface layer has a second surface structuring, wherein the first surface structuring and the second surface structuring have both been produced by a method according to the present disclosure.

This makes it possible to provide an edge strip that has a surface structuring on two sides. In this case, the first surface structuring and the second surface structuring can be different.

In a further embodiment of the edge strip, the first surface structuring and the second surface structuring have different visual patterns and/or different surface properties.

Such an edge strip can be adapted to its intended, later use, for example in the field of furniture production. In addition, this can eliminate the need for additional method steps for surface treatment.

Further features and advantages of the method and of the edge strip will become apparent from the following description of embodiments, wherein reference is made to the attached drawing.

### BRIEF DESCRIPTION OF THE DRAWINGS

FIG. 1 is a flowchart for an exemplary embodiment of a method for treating a surface;

FIG. 2 is a schematic representation of a first exemplary embodiment for applying a treatment medium to a carrier medium;

FIG. 3 is a schematic representation of a further exemplary embodiment for applying a treatment medium to a carrier medium;

FIG. 4 is an exemplary embodiment of a method for treating a surface;

FIG. 5 is a schematic representation of a substrate with a pattern; and

FIG. 6 is an exemplary embodiment of an edge strip in a sectional view.

### DETAILED DESCRIPTION

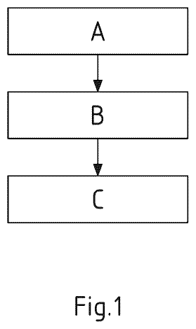

FIG. 1 shows a flow chart for an exemplary embodiment of a method for treating a surface. In a first step A, a liquid treatment medium is applied to a carrier medium. Following this and in a step B, the liquid treatment medium is transferred from the carrier medium to the surface of a substrate. The substrate has a surface that contains a thermoplastic. In step B, the thermoplastic has a temperature that lies above its melting temperature and is in a molten state. The transfer of the treatment medium from the carrier medium to the surface of the substrate in step B takes place before the solidification of the polymer material is complete, preferably before the start of a solidification process of the polymer material. In a step C, the transferred treatment medium interacts with the surface of the substrate in such a way that a surface structuring is created at the surface of the substrate.

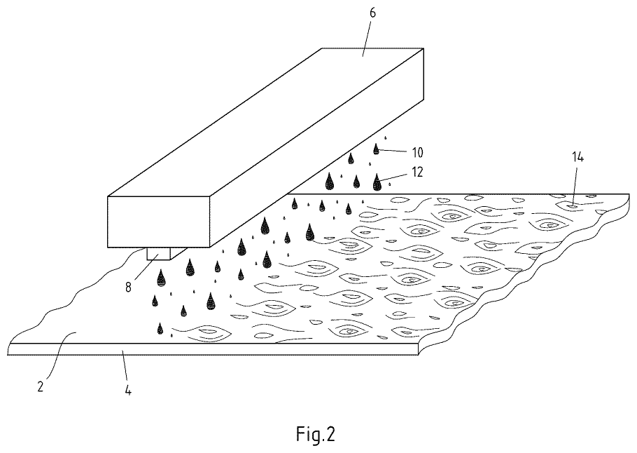

FIG. 2 shows a schematic representation of a first exemplary embodiment for applying a treatment medium to a carrier medium. Shown is a carrier medium 4 in the form of a plastic film with a surface 2. The carrier medium 4 moves from left to right and is exposed to an application module 6. The application module 6 has an inkjet head 8 and is arranged above the surface 2 of the carrier medium 4. The application module 6 applies a treatment medium 10 as droplets 12 to the surface 2 of the carrier medium 4 moving underneath. After the application, i.e. to the right of the application module 6 in FIG. 2, the treatment medium 10 is applied to the carrier medium 4 with a pattern 14.

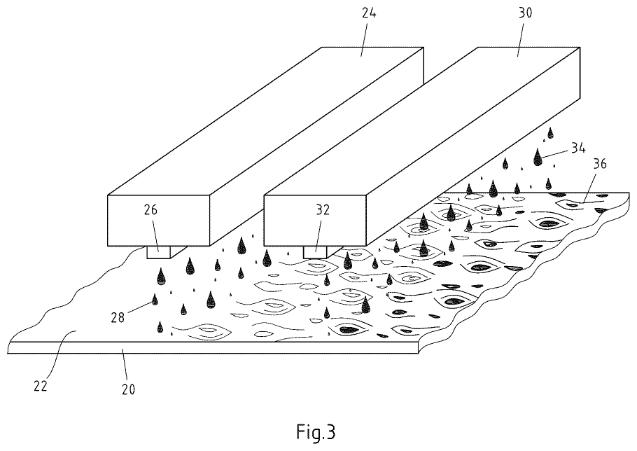

FIG. 3 shows a schematic representation of another exemplary embodiment for applying a treatment medium to a carrier medium. Accordingly, FIG. 3 also shows a carrier medium 20 in the form of a steel sheet having a surface 22 that moves from left to right, as well as a first application module 24 with a first inkjet head 26 and a first treatment medium 28. In addition, and in contrast to the exemplary embodiment in FIG. 2, a second application module 30 with a second ink-jet head 32 is provided, which is arranged above the strip 20 and after the first application module 24 in the direction of movement of the carrier medium 20. The second application module 30 applies a second treatment medium 34 to the surface 22 of the carrier medium 20. The first treatment medium 28 contains a first gloss control medium, and the second treatment medium 34 contains a second gloss control medium, wherein the first gloss control medium and the second gloss control medium are different. After the successive application, i.e. on the right in FIG. 3, the surface 22 of the carrier medium 20 has a pattern 36 which is formed by the treatment media 28 and 34 and is transferred to the surface of a substrate in a further step.

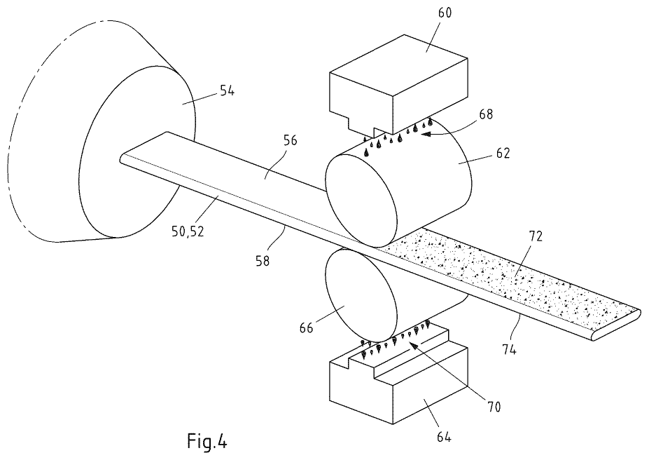

FIG. 4 shows a schematic representation of an exemplary embodiment of a method for treating a surface. A substrate 50 in the form of an extruded profile 52 exiting an extruder 54 is provided. The substrate 50 has a first surface 56 and a second surface 58 each of which has a thermoplastic that is still in a molten state from the manufacturing method by means of the extruder 54.

In the direction of movement of the extruded profile 52, a first application module 60, a second application module 64, a first carrier medium 62 and a second carrier medium 66 are provided. The first application module 60 is directed towards the first carrier medium 62, and the first carrier medium 62 is brought into contact with the first surface 56 of the substrate 50. The second application module 64 is directed toward the second carrier medium 66, and the second carrier medium 66 is in contact with the second surface 58 of the substrate 50.

With the first application module 60, a first liquid treatment medium 68 is applied to the first carrier medium 62. By rotating the first carrier medium 62 formed as a roller and contacting it with the first surface 56 of the substrate 50, the first treatment medium 68 is transferred from the first carrier medium 62 to the first surface 56. In an analogous manner, a second treatment medium 70 is applied to the second carrier medium 66 and transferred from the second carrier medium 66 to the second surface 58 of the substrate 50.

As a result, as in the right-hand part of FIG. 4, the substrate 50 or the extruded profile 52 has a first surface structuring 72 with an anti-microbial effect on the first surface 56 and a second surface structuring 74 with an increased Vickers hardness on the second surface 58.

FIG. 5 shows a schematic representation of a substrate 80 in the form of a film 82, the surface 84 of which has been treated by exposure to a liquid treatment medium. The surface 84 has matte regions 86 and shiny regions 88 that form a spot pattern. In the matte areas 86, the surface 84 has an increased surface roughness in comparison to the glossy areas 88, and thus a three-dimensional topography at the microscopic level.

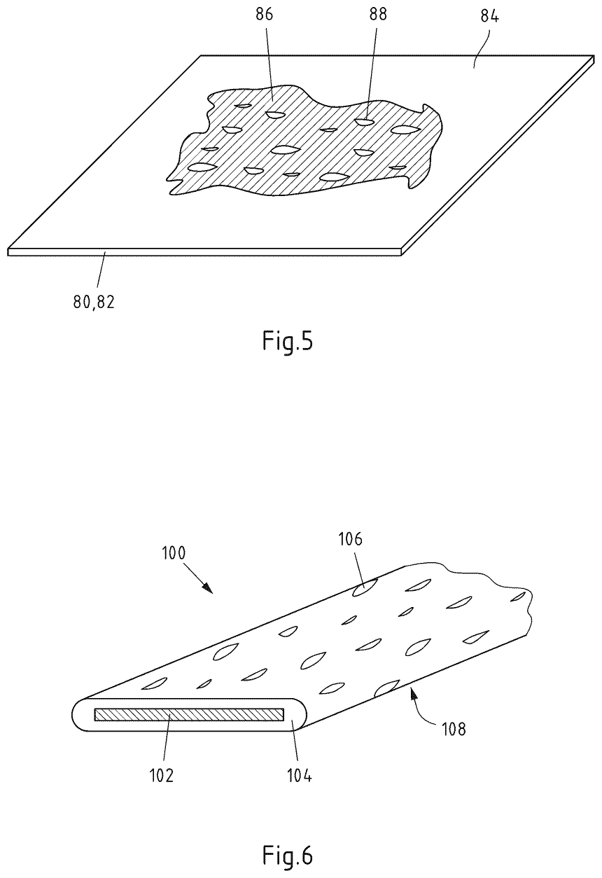

FIG. 6 shows an exemplary embodiment of an edge strip 100 in a sectional view. The edge strip 100 has a base body 102 with a first polymer material and a near-surface layer 104, which partially surrounds the base body 102, with a second polymer material. The first polymer material has a higher strength than the second polymer material and serves as a carrier material for the decorative or functional near-surface layer 104.

Areas of the near-surface layer 104 that are arranged on a first side of the base body 102 have a first surface structuring 106 that has been produced by interaction of the near-surface layer 104 with a treatment medium in the form of a nucleating agent. The near-surface layer 104 has further areas that are arranged on a second side of the base body 102, a second surface structuring 108 with a comparatively increased surface roughness. The second surface structuring 108 ensures that when a plurality of edge strips 100 are stacked on top of each other, they do not block each other.

1. A method for treating a surface the method comprising the steps of:
providing a substrate having the surface, wherein the surface at least partially comprises a polymer material, wherein the polymer material contains a thermoplastic polymer, a thermoplastic elastomer, or both, and wherein the polymer material at the surface of the substrate is at least partially in a molten state, and
applying a liquid treatment medium to a carrier medium (4, 20, 62, 66),
wherein the liquid treatment medium is transferred from the carrier medium to the surface of the substrate before the polymer material has completely solidified, and
wherein the transferred treatment medium interacts with the surface of the substrate in such a way that a surface structuring produced at the surface of the substrate.

2. The method according to claim 1, wherein the polymer material at the surface of the substrate has already been cooled and solidified at least once, and
wherein during the step of providing the substrate with a surface, the polymer material is again converted into a molten state.

3. The method according to claim 1, wherein the substrate is formed in one or more layers, in particular as a sandwich structure.

4. The method according to claim 1, wherein the substrate is provided in the form of a co-extruded edge strip with a near-surface layer and a base body, wherein the near-surface layer comprises a first polymer material with a first melt viscosity, and the base body comprises a second polymer material with a second melt viscosity, and
wherein the first melt viscosity is lower than the second melt viscosity.

5. The method according to claim 1, wherein the substrate is provided as an extrudate, and
wherein the substrate is exposed to the liquid treatment medium before the start of a cooling step.

6. The method according to claim 1, wherein the substrate is provided as an injection-molded part produced by an injection-molding method, and
wherein the polymer material has been converted back into a molten state after the injection-molding method.

7. The method according to claim 1, wherein the liquid treatment medium is applied to the carrier medium according to a prespecified pattern, and
wherein the pattern is reproduced during transfer of the liquid treatment medium from the carrier medium to the surface of the substrate in such a way that the surface structuring corresponds to the pattern.

8. The method according to claim 1, wherein the liquid treatment medium is provided with properties which have been selected depending on at least one property of the polymer material.

9. The method according to claim 1, wherein the liquid treatment medium contains at least one nucleating agent.

10. The method according to claim 1, wherein the liquid treatment medium contains at least one additive, in particular an additive from the list: dye; UV pigment; microbicide; gloss control agent; matting agent.

11. The method according to claim 1, wherein the polymer material of the substrate has been selected with respect to its melt viscosity.

12. The method according to claim 1, wherein either:
two or more portions of the treatment medium are transferred to the surface of the substrate, wherein the portions of the treatment medium have different temperatures, or
at least a first and a second treatment medium are transferred to the surface of the substrate.

13. The method according to claim 1, wherein the liquid treatment medium is applied to the carrier medium by an ink-jet method.

14. The method according to claim 1, wherein the liquid treatment medium ) is applied to the carrier medium by an airbrush method.

15. The method according to claim 1, wherein the liquid treatment medium is applied to the carrier medium (4, 20, 62, 66) by high-speed rotary atomization.

16. The method according to claim 1, wherein after transfer of the liquid treatment medium to the surface of the substrate, the surface of the substrate is post-treated, in particular in a cooling step, a fixing step, or both.

17. The method according to claim 1, wherein the temperature of the carrier medium is selected depending on properties of the liquid treatment medium depending on properties of the polymer material of the surface of the substrate, or both.

18. The method according to claim 1, wherein the material composition of the carrier medium, in particular the material composition of the surface of the carrier medium is selected depending on properties of the liquid treatment medium depending on properties of the polymer material of the surface of the substrate, or both.

19. The method according to claim 1, wherein for the transfer of the liquid treatment medium from the carrier medium to the surface of the substrate, the substrate at least partially wraps around the carrier medium with a wrap angle, and
the wrap angle is selected depending on one of: the properties of the liquid treatment medium the properties of the polymer material of the surface of the substrate, or the properties of a desired surface structuring

20. (canceled)

21. (canceled)

22. (canceled)

23. (canceled)

24. The method according to claim 1, wherein the polymer material is selected from the group consisting of polyethylene, polypropylene, acrylonitrile-butadiene-styrene copolymer, polyvinyl chloride, polymethyl methacrylate, polyethylene terephthalate, polylactic acid, thermoplastic styrene elastomers (TPS), thermoplastic urethane elastomers (TPU), thermoplastic polyamide elastomers (TPA), thermoplastic copolyester elastomers (TPC), thermoplastic olefin elastomers (TPO), thermoplastic vulcanizates (TPV), and mixtures thereof.

25. The method according to claim 1, wherein the polymer material on the surface of the substrate, which is in a molten state has a temperature which exceeds the melting temperature of the polymer material, in particular a temperature which exceeds the melting temperature of the polymer material by at least 15° C.

26. The method according to claim 1 wherein the carrier medium is a roller, in particular the surface of a roller, a plate, a strip, or a film.

27. The method according to claim 1, wherein the application of the treatment medium to the carrier medium is carried out by one of: being applied as droplets, by immersion in a bath, by thermal transfer, by spreading, or by application by a nozzle.

28. The method according to claim 1, wherein the transfer takes place by bringing together the carrier medium and the surface of the substrate and
wherein the carrier medium and the surface of the substrate are brought into contact, in particular pressed together.

29. The method according to claim 1, wherein the substrate is a solid component.

30. The method according to claim 1, the substrate is a film, an intermediate product, or component for the manufacture of furniture, floors, automobiles or windows.

31. The method according to claim 1, wherein the substrate is provided as an extrudate by being produced by post-co-extrusion, and
wherein a base body is produced by a first extruder, and then a surface layer is applied to the base body by a further extruder downstream of the first extruder, and
wherein the base body is at least partially solidified when the surface layer is applied as a melt stream.

32. The method according to claim 1, wherein the surface structuring corresponds to an imitation of a wood grain, stone, or metal surfaces.

33. The method according to claim 1, wherein the surface of the substrate as it is provided already has a surface structure, in particular a roughness or pattern caused by a preceding manufacturing step.

34. The method according to claim 1, wherein the surface structuring corresponds to a surface functionalization, and
wherein the surface functionalisation has an effect from the list of: a change in scratch resistance, an increase or decrease in permeability to gases or liquids, a change in resistance to environmental influences, a change in surface tension or surface hardness, an antimicrobial effect, a self-cleaning effect, a change in sliding properties or wetting behavior.

35. The method according to claim 1, wherein the liquid treatment medium contains at least one nucleating agent, wherein the at least one nucleating agent is one from the list of: dibenzylidene sorbitol (DBS), bis(p-methyldibenzylidene sorbitol) (MDBS), bis(p-ethyldibenzylidene sorbitol) (DMDBS), sodium 2,2′-methylene bis(4,6-di-tert-butylphenyl) phosphate, aluminum hydroxy bis(4-tert-butylbenzoate), N,N′-dicyclohexyl-2-6-naphthalenedicarboxamide, 4-biphenylcarboxylic acid, thymine, talc, sodium benzoate.

36. The method according to claim 1, wherein the treatment medium and the surface have temperatures selected such that the treatment medium evaporates after being transferred to the surface

37. The method according to claim 1 wherein two or more portions of the treatment medium are transferred to the surface of the substrate and
wherein the portions of the treatment medium have different temperatures.

38. The method according to claim 1, wherein at least a first and a second treatment medium are transferred to the surface of the substrate and
wherein the at least two liquid treatment media differ in their composition or physical state and are applied to the surface either simultaneously or with a time delay relative to one another.

39. The method according to claim 1, wherein at least a first and a second treatment medium are provided and applied to the surface, and
wherein the first treatment medium and the second treatment medium differ based on one or more of the following properties: polarity, solubility, surface tension.
